(19) United States
(12) Patent Application Publication
(10) Pub. No.: US 2005/0175217 A1
(43) Pub. Date: Aug. 11, 2005

(54) Using target images to determine a location of a stage

(76) Inventors: Louis F. Mueller, Palo Alto, CA (US); David C. Chu, Palo Alto, CA (US); Michael John Brosnan, Fremont, CA (US); William Clay Schluchter, Los Altos, CA (US); Jeffrey A. Young, Campbell, CA (US); Alan B. Ray, Palo Alto, CA (US); Douglas P. Woolverton, Mountain View, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/773,794

(22) Filed: Feb. 5, 2004

(51) Int. Cl. G06K 9/00

(52) U.S. Cl. 382/103

(57) ABSTRACT

The position of a stage is determined. Images of a plurality of targets located on the stage are captured. The captured images of the plurality of targets are compared with stored images to determine displacement coordinates for each target. The displacement coordinates for the targets are translated into position coordinates for the stage.

### BACKGROUND

The present invention relates to precise positioning of stages used in manufacturing and pertains particularly to using target images to determine a location of a stage.

Many manufacturing processes require precise positioning of stages used in manufacturing. What is meant by a stage is any platform or device used to support or hold an article of manufacture, or a stage is any object that can be attached to another object.

One part of the positioning used during manufacturing is to determine precisely where a stage is located in relation to a reference position. For example, when locating, relative to a reference position, a movable stage used in semiconductor processing, several types of systems can be used. For example, a self-mixing feedback laser can be used to determine a location relative to a reference position. See, for example, U.S. Pat. No. 6,233,045. However, accuracy of measurements using self-mixing feedback lasers is currently limited to 1 millimeter. This is insufficient for some applications.

For applications that require high resolution, other types of systems can be used to determine a location of a stage relative to a reference position. For example, a two wavelength, synthetic wavelength interferometer can be used. See, for example, U.S. Pat. No. 4,907,886. Alternatively, a grating sensor can be used. See, for example, U.S. Pat. No. 4,176.276. A disadvantage of each of these solutions is the relatively high expense associated with each of these systems.

Other types of systems can be used to precisely determine a location relative to a reference position. For example reflective sensors such as the Keyence photoelectric sensor PS 47 available from Keyence Corporation can be used. However, this system requires one sensor per degree of freedom, which complicates system geometry.

A fiber optic bundle sensor, such as the MTI-2000 Fotonic vibration sensor, available from MTI Instruments, Inc., can also be used. However, for such a fiber optic bundle sensor, there is typically a stage clearance of approximately 1 millimeters, which is insufficient for many applications.

### SUMMARY OF THE INVENTION

In accordance with an embodiment of the present invention, the position of a stage is determined. Images of a plurality of targets located on the stage are captured. The captured images of the plurality of targets are compared with stored images to determine displacement coordinates for each target. The displacement coordinates for the targets are translated into position coordinates for the stage.

### BRIEF DESCRIPTION OF THE DRAWINGS

FIG. 1 is a simplified diagram that shows a system used to find a location of a stage relative to a reference position in accordance with an embodiment of the present invention.

FIG. 2 is a simplified diagram of a sensor system including an imaging chip, optics and an optional illuminator in accordance with an embodiment of the present invention.

FIG. 3 is a simplified diagram of a target system including a target and optics in accordance with an embodiment of the present invention.

FIG. 4 is a simplified block diagram showing an example target pattern.

FIG. 5 is a simplified flowchart that describes the use of imaging to find a location of a stage relative to a reference position in accordance with an embodiment of the present invention.

FIG. 6 is a simplified diagram that shows a stage in accordance with another embodiment of the present invention.

### DESCRIPTION OF THE PREFERRED EMBODIMENT

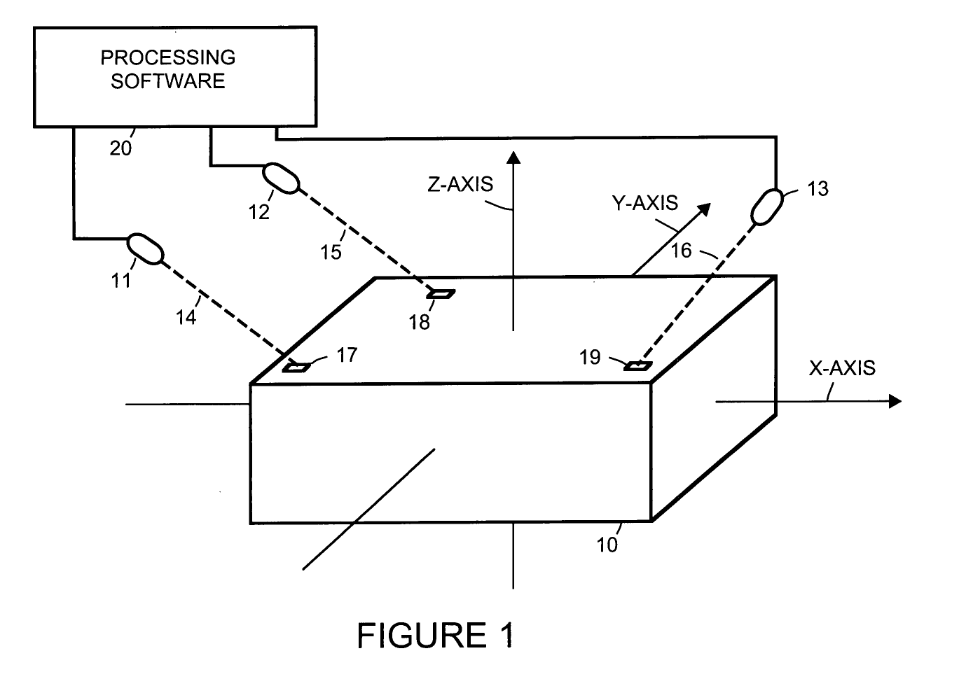

FIG. 1 is a simplified diagram that shows a system used to find a location of a stage 10 relative to a reference position. The system uses a sensor 11, a sensor 12 and a sensor 13. The three sensors 11, 12 and 13 are used to measure position in six degrees of freedom. The six degrees of freedom include, movement along three perpendicular axes (x-axis, y-axis, and z-axis) as well as rotation about the three perpendicular axes.

Sensor 11 illuminates and images a target area 17. Light between sensor 11 and target area 17 travels along a light path 14. Sensor 12 illuminates and images a target area 18. Light between sensor 12 and target area 18 travels along a light path 15. Sensor 13 illuminates and images a target area 19. Light between sensor 13 and target area 19 travels along a light path 16. Processing software 22 is used to process images captured from the targets and compare the images with stored images to produce displacement coordinates for each target. Processing software 22 then translates displacement coordinates for the targets into absolute position coordinates for stage 10, measured from a reference location. Portions of processing software 22 can reside within sensors 11, 12 and 13. Alternatively, processing software 22 used for image processing can be located completely outside sensors 11, 12 and 13 and in a separate processing system.

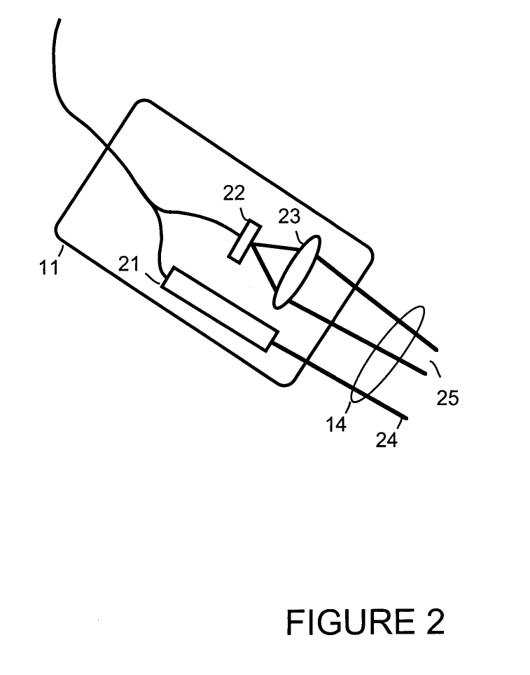

FIG. 2 is a simplified diagram of sensor 11. Sensor 11 is shown to include a light source 21, an imaging chip 22 and optics 23. For example, light source 21 is a low power source of non-coherent light of any color. Such a light source can be inexpensively implemented, for example, using a narrow angle light emitting diode (LED). Alternatively, light source 21 is not included within sensor 11 and target area 17 is self-illuminating.

Imaging chip 22 is for example, a complementary metal-oxide semiconductor (CMOS) imager or a charge coupled device (CCD) array or another type of imaging hardware or camera. Processing software 22 can be partially located within imaging chip 22. Alternatively, processing software 22 used for image processing can be located completely outside imaging chips and in a separate processing system.

Optics 23 include, for example one or more optic lenses. Optics 23 are used to magnify the image of a target within target area 17 and project the image towards a sensor of imaging chip 22 or a sensor package connected to imaging chip 22.

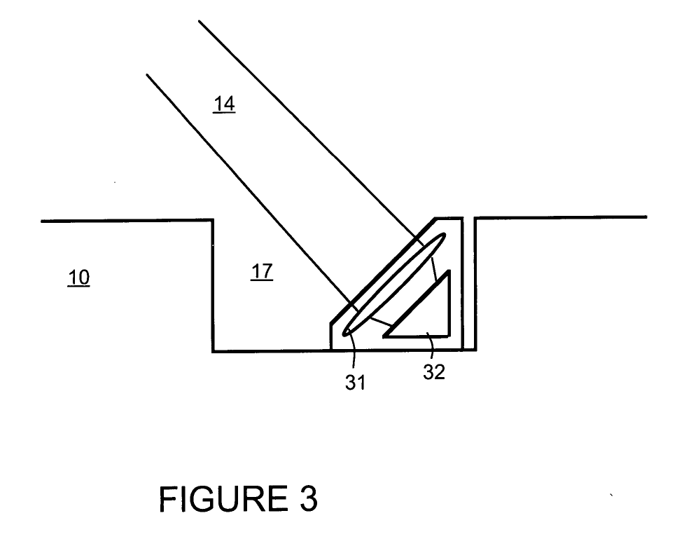

FIG. 3 is a simplified diagram that shows target area 17. Target area 17 is, for example an indented area within stage 10. A target structure 32 includes a target pattern, which is placed so that the target plane for the target pattern is at an oblique angle to the surfaces of stage 10. Optics 31 focus the target pattern within light path 14. Optics 31 include, for example, one or more optic lenses.

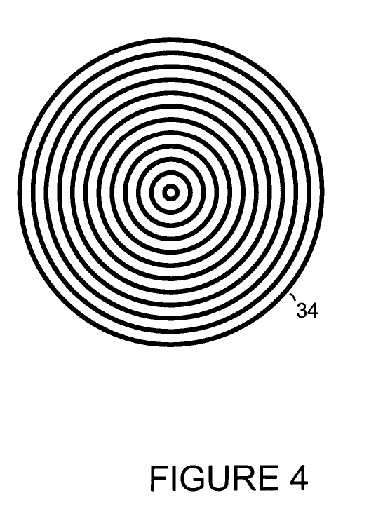

FIG. 4 shows an example of a target pattern 34. Target pattern 34 can vary dependent upon the algorithm used for image processing. A target pattern can be a regular pattern such as the concentric circle pattern shown in FIG. 4. Alternatively, target pattern 34 can be composed of an irregular or even random pattern.

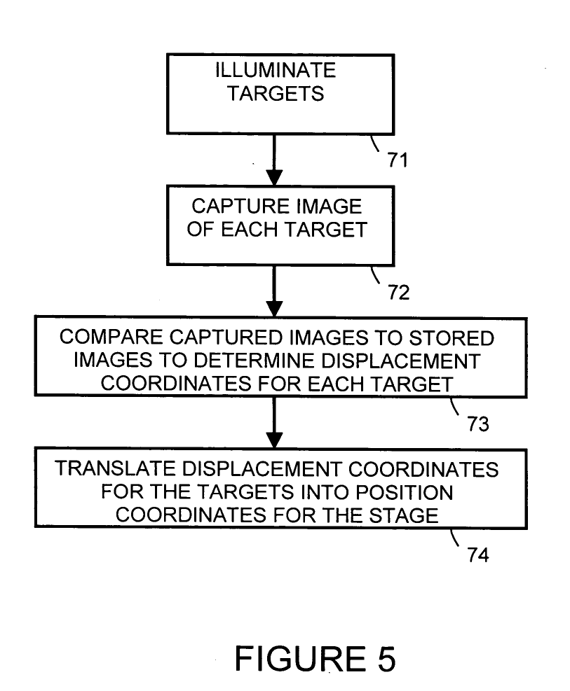

FIG. 5 is a simplified flowchart that describes the use of imaging to find a location of a stage relative to a reference position. In a block 71, light source 21 (shown in FIG. 2) illuminates target pattern 34 (shown in FIG. 4) in target area 17. In a block 72, an image of target pattern 34 is reflected along light path 14 back through optics 23 and captured by imaging chip 22 (shown in FIG. 2). Images of target patterns within target area 18 and target area 19 are also captured.

In a block 73, image processing software/firmware located either in imaging chips within sensors 11, 12 and 13 (shown in FIG. 1) or in an outside processing system is used to compare the captured images with reference images for each target stored in memory. For each captured image, displacement coordinates are calculated that indicate displacement between each captured image and the associated stored reference image.

In a block 74, the displacement coordinates reported by all of sensors 11, 12 and 13 are translated to calculate position coordinates for stage 50 in the six degrees of freedom.

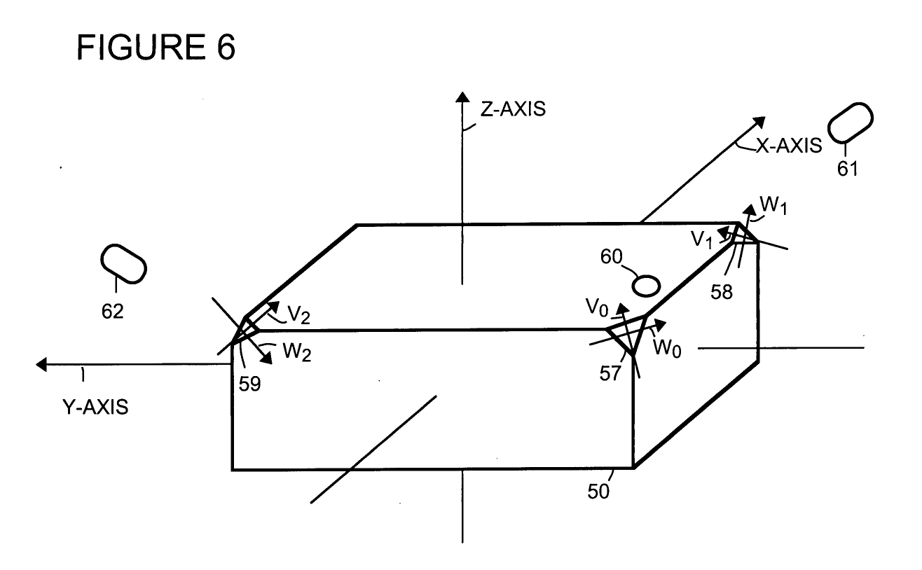

FIG. 6 shows a simplified embodiment of the present invention used to describe a typical algorithm used to translate the displacement coordinates for the three targets into stage motion coordinates in the six degrees of freedom. A stage 50 includes a target plane 57 located on one corner of stage 50. The area of target plane 57 is exaggerated and brought to a corner of stage 50 (from a small interior distance) for the purpose of simplifying the viewing of target plane 57. Stage 50 also includes a target plane 58 located on another corner of stage 50 and a target plane 59 located on another corner of stage 50. The areas of target plane 58 and target plane 58 are also exaggerated and brought to corners of stage 50 (from a small interior distance) for the purpose of simplifying the viewing of target plane 58 and target plane 59, respectively.

Target plane 57 is defined in two dimensions by a first coordinate W₀ and a second coordinate V₀. Target plane 58 is defined in two dimensions by a first coordinate W₁ and a second coordinate V₁. Target plane 59 is defined in two dimensions by a first coordinate W₂ and a second coordinate V₂.

The six degrees of freedom of motion for stage 50 are defined as translational movement (dx) along the x-axis, translational movement (dy) along the y-axis, translational movement (dz) along the z-axis, rotational movement (dRₓ) about the x-axis, rotational movement (dR_{y}) about the y-axis and rotational movement (dR_{y}) about the z-axis.

Dimensions of stage 50 are 2X along the x-axis, 2Y along the y-axis and 2Z along the z-axis. That is, the distance between target 57 and target 58 along the x-axis is 2X. The distance between target 57 and target 59 along the y-axis is 2Y. The distance between the plane defined by target 57, target 58 and target 59 and the xy plane along the z-axis is Z.

Target planes 57, 58 and 59 are all at Arctan (\sqrt{2}) or 54.73561 degrees, to the three orthogonal planes (xy plane, xz plane and yz plane) of stage 50.

A sensor 60 captures images of target plane 57 and thus is used to monitor coordinates (W₀, V₀). A sensor 61 captures images of target plane 58 and thus is used to monitor coordinates (W₁, V₁). A sensor 62 captures images of target plane 59 and thus is used to monitor coordinates (W₂, V₂). The optical axes of sensors 60, 61, 62 are nominally perpendicular to respective target planes 57, 58, 59 for the purpose of minimizing optical distortion of the target images.

Three dimensional translational movement (dx, dy, dz) and three dimensional rotational movement (dRₓ, dR_{y}, dR_{z}) of stage 50 cause target plane 58 to move a total of Δx, Δy₁, Δz₁ respectively along the x, y and z axes. The movement manifests in a change of target co-ordinates readings of ΔW₁ and ΔV₁ as follows:
ΔW₁=−αΔx₁−αΔy₁
ΔV₁=βΔx₁−βΔy₁−2βΔz₁,
where α=\sqrt{2/2} and β=\sqrt{6/6}.

The three dimensional translational movement (dx, dy, dz) and three dimensional rotational movement (dRₓ, dR_{y}, dR_{z}) of stage 50 cause target plane 57 to move a total of Δx₀, Δy₀, Δz₀ respectively along the x, y and z axes. The movement manifests in a change of target co-ordinates readings of ΔW₀ and ΔV₀ as follows:
ΔW₀=−α66 x₀+αΔy₀
ΔV₀=−βΔx₀−βΔy₀−2βΔz₀.

The three dimensional translational movement (dx, dy, dz) and three dimensional rotational movement (dRₓ, dR_{y}, (dR_{z}) of stage 50 cause target plane 59 to move a total of Δx₂, Δ₂, Δz₂ respectively along the x, y and z axes. The movement manifests in a change of target co-ordinates readings of ΔW₂ and ΔV₂ as follows:
ΔW₂=αΔx₂+αΔy₂
ΔV₂=−βΔx₂+βΔy₂−2βΔz₂.

Total movements Δx, Δy, Δz at each target location due to both stage translation (dx, dy, dz) and stage rotation (dRₓ, dR_{y}, dR_{z}) are related by simple geometry, as set out in Table 1 below:

TABLE 1

| | |
|---|---|
| Δx₁ = dx | −Z · dR_{y} − Y · dR_{z} |

| | |
|---|---|
| Δy₁ = dy + Z · dRₓ | −X · dR_{z} |

| Δz₁ = dz + Y · dRₓ + X · dR_{y} | |
|---|---|
| Δx₀ = dx | −Z · dR_{y} − Y · dR_{z} |

| | |
|---|---|
| Δy₀ = dy + Z · dRₓ | +X · dR_{z} |

| Δz₀ = dz + Y · dRₓ − X · dR_{y} | |
|---|---|
| Δx₂ = dx | −Z · dR_{y} + Y · dR_{z} |

| | |
|---|---|
| Δy₂ = dy + Z · dRₓ | +X · dR_{z} |

Δz₂ = dz − Y · dRₓ − X · dR_{y}

Cascading by matrix multiplication, changes in the six target co-ordinates (ΔW₁, ΔV₁, ΔW₀, ΔV₀, ΔW₂, ΔV₂) can be obtained from the six stage movements (dx, dy, dz, dRₓ, dR_{y}, dR_{z}) as set out in Table 2 below:

TABLE 2
$[ \begin{matrix}{ΔW}_{1} / α \\ {ΔW}_{1} / β \\ {ΔW}_{0} / α \\ {ΔV}_{0} / β \\ {ΔW}_{2} / α \\ {ΔV}_{2} / β\end{matrix} ] = [ \begin{matrix}- 1 & - 1 & 0 & - Z & Z & X + Y \\ 1 & - 1 & - 2 & - ( 2 Y + Z ) & - ( 2 X + Z ) & X - Y \\ - 1 & 1 & 0 & - Z & Z & X + Y \\ - 1 & - 1 & - 2 & - ( 2 Y + Z ) & 2 X + Z & - X + Y \\ 1 & 1 & 0 & Z & - Z & X + Y \\ - 1 & 1 & - 2 & 2 Y + Z & 2 X + Z & X - Y\end{matrix} ] * [ \begin{matrix}dx \\ dy \\ dz \\ {dR}_{x} \\ {dR}_{y} \\ {dR}_{z}\end{matrix} ]$

Conversely, the six stage movements (dx, dy, dz, dRₓ, dR_{y}, dR_{z}) can be computed from the changes of the six target co-ordinates (ΔW₁, ΔV₁, ΔW₀, ΔV₀, ΔW₂, ΔV₂) by a scaled inverse of the above 6×6 matrix. The six target co-ordinates (ΔW₁, ΔV₁, ΔW₀, ΔV₀, ΔW₂, ΔV₂) are monitored by sensor 61, sensor 60 and sensor 62. This is illustrated in Table 3 below:

TABLE 3
$[ \begin{matrix}dx \\ dy \\ dz \\ {dR}_{x} \\ {dR}_{y} \\ {dR}_{z}\end{matrix} ] = [ \begin{matrix}\frac{Z ( X - Y )}{X ( X + Y )} & - \frac{Z}{X} & - \frac{2 X + Z}{X} & \frac{Z}{X} & \frac{2 ( X + Y + Z )}{X + Y} & 0 \\ - \frac{2 ( X + Y + Z )}{X + Y} & 0 & \frac{2 Y + Z}{Y} & \frac{Z}{Y} & \frac{Z ( X - Y )}{Y ( X + Y )} & - \frac{Z}{Y} \\ \frac{X - Y}{X + Y} & - 1 & 0 & 0 & \frac{X - Y}{X + Y} & - 1 \\ \frac{2}{X + Y} & 0 & - \frac{1}{Y} & - \frac{1}{Y} & \frac{- X + Y}{Y ( X + Y )} & \frac{1}{Y} \\ \frac{X - Y}{X ( X + Y )} & - \frac{1}{X} & - \frac{1}{X} & \frac{1}{X} & \frac{2}{X + Y} & 0 \\ \frac{2}{X + Y} & 0 & 0 & 0 & \frac{2}{X + Y} & 0\end{matrix} ] * [ \begin{matrix}\frac{{ΔW}_{1}}{4 α} \\ \frac{{ΔV}_{1}}{4 β} \\ \frac{{ΔW}_{0}}{4 α} \\ \frac{{ΔV}_{0}}{4 β} \\ \frac{{ΔW}_{2}}{4 α} \\ \frac{{ΔV}_{2}}{4 β}\end{matrix} ]$

It is convenient to define the x-axis and the y-axis to be on the plane defined by the three targets 57, 58 and 59. That is, target 57, target 58 and target 59 lie on the xy plane. In effect, Z equals 0. For this design, the transformation set out in Table 3 simplifies to the transformation set out in Table 4 below:

TABLE 4
$[ \begin{matrix}dx \\ dy \\ dz \\ {dR}_{x} \\ {dR}_{y} \\ {dR}_{z}\end{matrix} ] = [ \begin{matrix}0 & 0 & - 2 & 0 & 2 & 0 \\ - 2 & 0 & 2 & 0 & 0 & 0 \\ \frac{X - Y}{X + Y} & - 1 & 0 & 0 & \frac{X - Y}{X + Y} & - 1 \\ \frac{2}{X + Y} & 0 & - \frac{1}{Y} & - \frac{1}{Y} & \frac{- X + Y}{Y ( X + Y )} & \frac{1}{Y} \\ \frac{X - Y}{X ( X + Y )} & - \frac{1}{X} & - \frac{1}{X} & \frac{1}{X} & \frac{2}{X + Y} & 0 \\ \frac{2}{X + Y} & 0 & 0 & 0 & \frac{2}{X + Y} & 0\end{matrix} ] * [ \begin{matrix}\frac{{ΔW}_{1}}{4 α} \\ \frac{{ΔV}_{1}}{4 β} \\ \frac{{ΔW}_{0}}{4 α} \\ \frac{{ΔV}_{0}}{4 β} \\ \frac{{ΔW}_{2}}{4 α} \\ \frac{{ΔV}_{2}}{4 β}\end{matrix} ]$

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

1. A method to determine a position of a stage, comprising:
capturing images of a plurality of targets located on the stage;
comparing the captured images of the plurality of targets with stored images to determine displacement coordinates for each target; and,
translating the displacement coordinates for the targets into position coordinates for the stage.

2. A method as in claim 1 wherein capturing images includes:
illuminating the plurality of targets.

3. A method as in claim 1 wherein the plurality of targets includes three targets.

4. A method as in claim 1 wherein the capture of the images is performed by a plurality of sensors, one sensor for each target.

5. A method as in claim 1 wherein comparison of the captured images of the plurality of targets with the stored images is performed by imaging chips within a plurality of sensors, one sensor for each target.

6. A method as in claim 1 wherein there are two displacement coordinates for each target.

7. A method as in claim 1 wherein there are six position coordinates for the stage.

8. A method as in claim 1 wherein the targets are placed at oblique angles to all surfaces of the stage.

9. A method as in claim 1:
wherein each target is placed so a target plane for each target is at an oblique angle to all surfaces of the stage;
wherein the capture of the images is performed by a plurality of sensors; and,
wherein for each target, a sensor from the plurality of sensors is aligned nominally perpendicular to the target plane.

10. A method as in claim 1 wherein there are six position coordinates for the stage, the six position coordinates being:
translational movement along a first axis;
translational movement along a second axis;
translational movement along a third axis;
rotational movement about the first axis;
rotational movement about the second axis; and,
rotational movement about the third axis.

11. A system to determine a position of a stage, comprising:
capturing hardware that captures an image for each of a plurality of targets located on the stage; and,
processing software that compares the captured images of the plurality of targets with stored images to determine displacement coordinates for each of the plurality of targets and translates the displacement coordinates for the targets into position coordinates for the stage.

12. A system as in claim 11 wherein the capturing hardware includes a plurality of light sources that illuminate each of the plurality of targets.

13. A system as in claim 11 wherein the plurality of targets includes three targets.

14. A system as in claim 11 wherein the capturing hardware is located in a plurality of sensors, one sensor for each target.

15. A system as in claim 11 wherein there are two displacement coordinates for each target.

16. A system as in claim 11 wherein there are six position coordinates for the stage.

17. A system as in claim 11 wherein the position coordinates for the stage are absolute coordinates from a reference location.

18. A system as in claim 11 wherein there are six position coordinates for the stage, the six position coordinates being:
translational movement along a first axis;
translational movement along a second axis;
translational movement along a third axis;
rotational movement about the first axis;
rotational movement about the second axis; and,
rotational movement about the third axis.

19. A system to determine a position of a stage, comprising:
capturing means for capturing an image for each of a plurality of targets located on the stage; and,
processing means for comparing the captured images of the plurality of targets with stored images to determine displacement coordinates for each of the plurality of targets and translating the displacement coordinates for the targets into position coordinates for the stage.

20. A system as in claim 19 wherein there are six position coordinates for the stage, the six position coordinates being:
translational movement along a first axis;
translational movement along a second axis;
translational movement along a third axis;
rotational movement about the first axis;
rotational movement about the second axis; and,
rotational movement about the third axis.
